(19) United States
(12) Patent Application Publication
(10) Pub. No.: US 2008/0092619 A1
(43) Pub. Date: Apr. 24, 2008

(54) Apparatus for reforming rod-shaped and/or tubular, electrically conductive materials

(76) Inventors: Werner Witte, Unna (DE); Peter Bilstein, Menden (DE); Lothar Illgen, Iserlohn (DE); Bernhard Oswald, Mittenborg (DE)

Correspondence Address: Hoffman, Wasson & Gitler, P.C., Suite 522, 2461 South Clark Street, Arlington, VA, 22202, US

(21) Appl. No.: 11/905,759

(22) Filed: Oct. 3, 2007

Related U.S. Application Data
(63) Continuation-in-part of application No. 11/108,914, filed on Apr. 19, 2005, now abandoned.

(30) Foreign Application Priority Data
May 14, 2004 (EP) 04 011 494.4
Apr. 22, 2004 (DE) 10 2004 020 224.9

(51) Int. Cl. B21C 1/32; B28B 17/00

(52) U.S. Cl. 72/287; 425/3

(57) ABSTRACT

An apparatus for reforming rod-shaped and/or tubular, electrically conductive and/or magnetizable materials, in particular for drawing or extruding: the apparatus has an inductor of an electric linear motor, by means of which a traveling electromagnetic field can be produced; the inductor includes coils which are arranged axially next to one another; the coils form a channel; the apparatus includes one or more means for conducting a magnetic flux which are arranged in the channel such that they can be removed.

This application is a continuation-in-part of Ser. No. 11/108,914, filed Apr. 19, 2005.

### BACKGROUND OF THE INVENTION

The invention relates to an apparatus for reforming rod-shaped and/or tubular, electrically conductive and possibly magnetizable materials, in particular to an apparatus for drawing or extruding by passing the material through a die.

The patent specification having the number U.S. Pat. No. 3,911,706 A discloses an apparatus of the type mentioned initially which has an inductor of an electric linear motor. This inductor has coils, which are arranged axially next to one another such that the center of the coils which remains free forms a channel. The rod-shaped or tubular material, which is to be reformed and which is electrically conductive and possibly magnetizable, is introduced into this channel. This material then forms the armature of the linear motor. Owing to the fact that a traveling magnetic field is produced in the channel of the inductor, the armature, i.e. the material to be reformed, is moved on in the channel. In the process, with appropriate conductance of the inductor, the material to be reformed can be moved through the die of an apparatus of the type mentioned initially, as a result of which the material is reformed.

The abovementioned document having the patent number U.S. Pat. No. 3,911,706 A discloses a linear drawing machine for drawing a rod-shaped material through the die of a female mold. For this purpose, the inductor is arranged such that it lies downstream of the die in the drawing direction. The rod-shaped material which is inserted into the die in a manner which is not disclosed in any more detail is passed through the inductor downstream of the die in the drawing direction, as a result of which the inductor, interacting with the rod-shaped drawing material which acts as the armature, forms a linear motor which draws the rod-shaped drawing material through the die and thus brings about the required force for the reforming process.

The disadvantage of the drawing apparatus disclosed in the abovementioned document is the fact that the forces produced by the inductor interacting with the drawing material are only sufficient for a reforming process, in particular for larger drawing materials, if the inductor has a length of several 100 m. Such a drawing machine, however, is unrealistic since it cannot be produced and operated at reasonable cost.

A further disadvantage is the fact that, owing to the channel size prescribed by the inductor, the apparatus is only designed for drawing materials of one diameter or of one range of diameters.

The present invention was therefore based on the object of developing an apparatus for reforming tubular or rod-shaped drawing material of the type mentioned initially such that forces can be brought about even using smaller machines in order to achieve reforming of the tubular or rod-shaped material. In addition, the apparatus will also be suitable for drawing materials having different diameters or different ranges of diameters.

### SUMMARY OF THE INVENTION

Accordingly, an apparatus according to the invention for reforming rod-shaped and/or tubular materials has one or more means for conducting a magnetic flux which are arranged in the channel such that they can be removed.

Tests on a reforming apparatus of the type mentioned initially have shown that the magnetic flux is not conducted in optimum fashion in or through the tubular or rod-shaped material to be reformed for optimum force to be produced which acts on the material to be reformed in order to move it. This could be attributed to air gaps which remain, for example, between the inner wall of the channel and the outer surface of the material to be reformed. Experiments have now shown that, by introducing a means for conducting the magnetic flux into the channel, the magnetic flux in the tubular or rod-shaped material to be reformed is combined such that the force which acts on the material to be reformed can be increased by a factor greater than 10. It is thus then possible to achieve a considerable reduction in the physical size of the apparatus of the type mentioned initially. An apparatus according to the invention is as a result more compact and can be operated in a significantly more cost-effective manner.

An apparatus according to the invention may have a tube as a first means for conducting the magnetic flux. This tube may have first sections made of a magnetizable, in particular soft-magnetic material and second sections made of a non-magnetizable or comparatively only weakly magnetizable material. In this case, the sections are advantageously in the form of sleeves. The sections of a tube of an apparatus according to the invention are arranged coaxially next to one another. The sections thus together form the tube.

The material of the first sections of an apparatus according to the invention may be a metal, in particular iron, or else a material which contains metal and in particular iron. The material may also be cobalt, nickel or cobalt, nickel or iron alloys. The material advantageously has a high saturation field strength. The material may be a powder metal. The material may likewise be powder-sintered or composed of laminated layers. It may likewise be provided with slots in the longitudinal direction.

The material from which the second sections are produced may advantageously be a plastic.

The alternate arrangement of the sections makes it possible for the magnetic flux to be passed, in combined form, to the material to be reformed.

The tube must have an outer diameter which is not larger than the inner diameter of the channel, such that it is possible to insert the tube in the channel. However, the outer diameter is advantageously the same size as or only slightly smaller than the diameter of the channel. In addition, the tube has an inner diameter which is slightly larger than the material to be reformed. Overall, it should be possible for the air gap, which is between the inner wall of the channel and the material to be reformed, to be as small as possible and to be filled as much as possible with the means for conducting the magnetic flux.

The inductor of an apparatus according to the invention may include perforated disks, which are arranged between the coils coaxially with respect to the coils and which form, together with the coils, the channel of the inductor. The disks make it possible for the magnetic flux, which is produced by the coils of the inductor, to be combined even in the regions between the coils. The disks may have a radial slot. If the disks are provided in the case of the inductor, it is advantageous if the second sections of the tube have a width which corresponds to the width of the coils. The tube is advantageously pushed into the inductor such that the second sections are aligned with the coils and the first sections are aligned with the disks.

In the case of tubular materials, it has also been shown that the cavity within the tube leads to the magnetic flux not being passed through the tubular material to be reformed in optimum fashion. If, instead, a second means for conducting the magnetic flux in the form of a cylinder is introduced into the inductor of an apparatus of the type mentioned initially, this leads to the flux being conducted through the tubular material to be reformed with an optimum alignment. The cylinder, which is arranged in the inductor as the second means for conducting the magnetic flux, is advantageously arranged in the channel coaxially with respect to the coils.

The cylinder of an apparatus according to the invention is advantageously dimensioned such that a gap which is as small as possible remains between the cylinder and an inner wall face of the channel or the inner wall face of the first means for the purpose of inserting and passing through the tubular material to be reformed.

According to the invention, the cylinder may be a hollow cylinder.

The cylinder is advantageously produced from a material which includes a metal, in particular iron. The material may also be cobalt, nickel or cobalt, nickel or iron alloys. The material advantageously has a high saturation field strength. In addition, it is possible for the cylinder to be produced from a powder metal. The material may likewise be powder-sintered or composed of laminated layers. It may likewise be provided with slots in the longitudinal direction.

The cylinder can be retained on the drawing mandrel, for example, by means of mechanical and/or electromagnetic retaining means. The cylinder made of a soft-magnetic and ferromagnetic material may be retained, for example, by the coils of the inductor or further coils, the coils having an alternating current or a direct current flowing through them.

It is advantageously possible with an apparatus according to the invention to produce a traveling electromagnetic field which has a magnetic flux density having a gradient in the axial direction of the channel which has an amplitude of greater than B=1 T. The electrical current density which can be produced by the coils of the inductor is advantageously greater than J=10 A/mm².

At least some of the coils may have conductors which have a resistivity of ρ=0.017×10⁻⁶Ωm or less. At least some of the coils may have conductors which are superconductive. The superconductive conductors of such coils may be made of a material which has a critical temperature of greater than T=77 K.

### BRIEF DESCRIPTION OF THE DRAWING

An exemplary embodiment of an inductor of an apparatus according to the invention is described in more detail with reference to the drawing, in which:

FIG. 1 shows the inductor according to the invention having a first and a second conducting means and a tubular drawing material being pulled through a die.

### DETAILED DESCRIPTION OF THE INVENTION

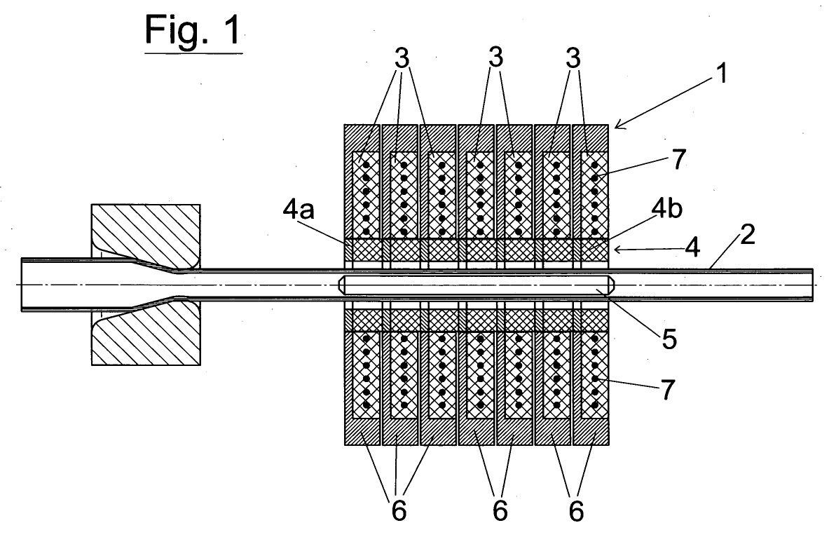

The inductor 1 according to the invention and illustrated in FIG. 1 of a linear motor has coils 3, which are arranged coaxially next to one another. Perforated disks 6, which cover the outer edge of the coils, are arranged between these coils 3. The disks cover the coils 3 such that the protruding edge of the disks 6 ends flush with the coil. The disk 6 and the coil 3 embedded therein thus form a body which forms a ring having a rectangular cross section. If these bodies comprising the disk 6 and the coil 3 are arranged next to one another, as a result the coils are completely, with the exception of on the inside, enclosed by the directly associated disk 6 or an adjacent disk 6.

The coils 3 and the disks 6 together form a channel, through which the material 2 to be reformed is transported. The transport takes place in this case by means of forces which act on the material 2 owing to electromagnetic induction and mutual induction.

The disks 6 are produced from a powder metal. The disks serve the purpose of combining and conducting the magnetic flux produced by the coils.

If the material to be reformed is now introduced into the channel, and this material 2 to be reformed has an outer diameter which is considerably smaller than the inner diameter of the channel, this leads to the magnetic flux partially being conducted through the remaining air gap between the material 2 to be reformed and the inner wall of the channel and not through the material 2 to be reformed itself.

In order to prevent this, the first means 4 is pushed into the channel. In this case, a tube 4 is used, which may comprise first sections 4a and second sections 4b, which are in the form of sleeves and which are arranged coaxially next to one another such that they form a tube. This tube has an outer diameter which corresponds to the inner diameter of the channel. The inner diameter of the tube, on the other hand, corresponds approximately to the outer diameter of the material 2 to be reformed. The first sections 4a of the tube 4 are likewise produced from a powder metal. These first sections can thus combine and conduct the magnetic flux which is produced by the coils 3 in the same manner as the disks 6. The second sections 4b, on the other hand, are produced from a plastic. These sections 4b cannot combine the magnetic flux. As long as the tube 4 is pushed into the channel, the first sections 4a of the tube 4 form a bridge over the otherwise remaining air gap, which leads to optimum guidance of the magnetic flux. The magnetic flux can be introduced into the material 2 to be reformed in combined form.

The tube is removable from the channel. By removable, it is meant that the tube may be removed from either end of the channel without dismantling the entire device. The tube may be retained in the channel in any suitable manner. One possibility is to a link or plate that is secured to an end of the tube with the other end secured to the disks 6.

The material to be reformed which is illustrated in FIG. 1 is a tubular material 2 pulled through a die 8. Alternatively, the die call be placed at the exit end of the inductor and pushed through the die. The interior which remains free in the tubular material 2 is likewise not optimal for the production of the force which acts on the material 2 to be reformed. According to the invention, a second conducting means has therefore been inserted into the channel. This second means is formed by a cylinder 5 which has a diameter which is smaller than the inner diameter of the material to be reformed. As long as the material 2 to be reformed has not inserted into the channel, a gap would thus remain between the cylinder 5 and the tube 4 or the inner wall of the channel, and a tubular material to be reformed can be inserted into this gap. The cylinder 5, which may also be a hollow cylinder, is likewise produced from a powder metal, and the cylinder results, as is also the case for the first sections 4a and the disks 6, in a combined magnetic flux. This makes it possible for the magnetic flux to flow essentially radially through the tubular material 2 to be reformed, which is optimal for force production.

What is claimed is:

1. An apparatus for forming rod shaped or tubular drawing material comprising
an inductor producing a traveling electromagnetic field, said inductor comprising
a plurality of coils arranged axially next to one another,
a channel formed by said coils, the channel having an inner wall having an inner diameter and an opening at each end,
a tube removable retained within the channel, the tube conducting magnetic flux induced by the inductor,
a drawing die at one end of the channel,
wherein the traveling electromagnetic field induces forces to move material through the inductor and the die.

2. The apparatus of claim 1, wherein the tube has an outer diameter equal to the inner diameter of the channel and an inner diameter substantially equal to the outer diameter of the material passing through the inductor.

3. An apparatus for advancing rod-shaped and/or tubular, electrically conductive and/or magnetizable materials comprising an inductor producing a traveling electromagnetic field;
the inductor comprises coils which are arranged axially next to one another;
the coils form a channel; and
the apparatus further comprises one or more means for conducting a magnetic flux which are arranged in the channel such that they can be removed wherein the inductor is used in the channel to produce a traveling field with a magnetic flux density having a gradient in the axial direction of the channel which has an amplitude of greater than B=1 T.

4. The apparatus as claimed in claim 3, wherein the tube has first sections made of a magnetizable material and second sections made of a non-magnetizable or only weakly magnetizable material.

5. The apparatus as claimed in claim 4, wherein the first and second sections are in the form of sleeves.

6. The apparatus as claimed in claim 4, wherein the first and second sections are arranged coaxially next to one another.

7. The apparatus as claimed in claim 4, wherein the material of the first sections is or contains a soft-magnetic metal or iron.

8. The apparatus as claimed in claim 4, wherein the material of the second sections is a plastic.

9. The apparatus as claimed in claim 4, wherein the tube has an outer diameter which is the same size as or slightly smaller than a diameter of the channel.

10. The apparatus as claimed in claim 3, wherein the tube has an inner diameter which is slightly larger than a material to be placed within the tube.

11. The apparatus as claimed in claim 3, wherein the inductor comprises disks, which are arranged between the coils coaxially with respect to the coils and which form, with the coils, the channel.

12. The apparatus as claimed in claim 11, wherein the tube has first sections and second sections, the second sections of the tube have a width which corresponds to the width of the coils or is smaller than this width.

13. The apparatus as claimed claim 3, further comprising a cylinder, the cylinder conducting magnetic flux.

14. The apparatus as claimed in claim 13, wherein the cylinder is arranged in the channel coaxially with respect to the coils.

15. The apparatus as claimed in claim 14, wherein the apparatus has, between the cylinder and an inner wall face of the tube, a gap for inserting and passing through a material to be placed within the tube.

16. The apparatus as claimed in claim 13, wherein the cylinder is a hollow cylinder.

17. The apparatus as claimed in claim 13, wherein the cylinder is produced from a material which comprises a soft-magnetic metal, or iron.

18. The apparatus as claimed in claim 13, wherein the cylinder is a powder metal, is a powder-sintered metal or is laminated from layers or provided with longitudinal slots.

19. The apparatus as claimed in claim 3, wherein, when using the coils, electrical current densities of greater than J=10 A/mm² can be produced.

20. An apparatus for advancing rod-shaped and/or tubular, electrically conductive and/or magnetizable materials comprising
an inductor producing a traveling electromagnetic field;
the inductor comprises coils which are arranged axially next to one another;
the coils form a channel; and
the apparatus further comprises one or more means for conducting a magnetic flux which are arranged in the channel such that they can be removed, at least some of the coils have conductors which are superconductive
wherein the superconductive conductors are made of a material which has a critical temperature of greater than T=77 K.
